(19) United States
(12) Patent Application Publication
(10) Pub. No.: US 2016/0138575 A1
(43) Pub. Date: May 19, 2016

(54) AN ENERGY RECOVERY DEVICE

(71) Applicant: EXERGYN LTD., Dublin (IE)

(72) Inventors: Barry Cullen, Dublin (IE); Ronan Byrne, Dublin (IE); Kevin O'Toole, Dublin (IE)

(21) Appl. No.: 14/898,214

(22) PCT Filed: Jun. 13, 2014
(86) PCT No.: PCT/EP2014/062432

§ 371 Date: Dec. 14, 2015

(30) Foreign Application Priority Data
Jun. 13, 2013 (GB) 1310511.9

(51) Int. Cl. F03G 7/06; F15B 1/02

(52) U.S. Cl. CPC F03G 7/065; F15B 1/024

(57) ABSTRACT

The invention provides an energy recovery device comprising a drive mechanism configured with a transmission system; a SMA engine comprising a length of SMA material fixed at a first end and connected at a second end to the drive mechanism; an immersion chamber adapted for housing the SMA engine and adapted to be sequentially filled with fluid to allow heating and/or cooling of the SMA engine; and an output transmission for coupling to and being driven by a gear based or hydraulic based transmission system.

### FIELD

The present application relates to the field of energy recovery and in particular to the use of shape memory alloys (SMA) for same.

### BACKGROUND

Low grade heat, which is typically considered less than 100 degrees, represents a significant waste energy stream in industrial processes, power generation and transport applications. Recovery and re-use of such waste streams is desirable. An example of a technology which has been proposed for this purpose is a Thermoelectric Generator (TEG). Unfortunately, TEG's are relatively expensive. Another largely experimental approach that has been proposed to recover such energy is the use of Shape Memory Alloys.

A shape-memory alloy (SMA) is an alloy that “remembers” its original, cold-forged shape which once deformed returns to its pre-deformed shape upon heating. This material is a lightweight, solid-state alternative to conventional actuators such as hydraulic, pneumatic, and motor-based systems.

The three main types of shape-memory alloys are the copper-zinc-aluminium-nickel, copper-aluminium-nickel, and nickel-titanium (NiTi) alloys but SMAs can also be created, for example, by alloying zinc, copper, gold and iron.

The memory of such materials has been employed or proposed since the early 1970's for use in heat recovery processes and in particular by constructing SMA engines which recover energy from heat as motion.

In a first type, referred to as a crank engine, of which U.S. Pat. No. 4,683,72 is an example, convert the reciprocating linear motion of an SMA actuator into continuous rotary motion, by eccentrically connecting the actuator to the output shaft. The actuators are often trained to form extension springs. Some configurations require a flywheel to drive the crank through the mechanism's limit positions. A related type are Swash Plate Engines, which are similar to cranks except that their axis of rotation is roughly parallel to the direction of the applied force, instead of perpendicular as for cranks.

A second type are referred to as a pulley engines, an example of which is U.S. Pat. No. 4,010,612. In pulley engines, continuous belts of SMA wire is used as the driving mechanism. A pulley engine may be unsynchronized or synchronized. In unsynchronized engines, the pulleys are free to rotate independently of one another. The only link between different elements is rolling contact with the wire loops. In contrast, in synchronized engines, the pulleys are constrained such that they rotate in a fixed relationship. Synchronization is commonly used to ensure that two shafts turn at the same speed or keep the same relative orientation.

A third type of SMA engine may be referred to as field engines, an example of which is U.S. Pat. No. 4,027,479. In this category, the engines work against a force, such as a gravitational or magnetic field.

A fourth type of SMA engine is that of Reciprocating Engines of which U.S. Pat. No. 4,434,618 in an example. These reciprocating engines operate linearly, in a back-and-forth fashion, as opposed to cyclically.

A fifth type of SMA engine is that of Sequential Engines of which U.S. Pat. No. 4,938,026 is an example. Sequential engines move with small, powerful steps, which sum to substantial displacements. They work like an inchworm, extending the front part by a small step and then pulling the back part along. With the back part nearby, the front part can extend again.

A sixth type of SMA engine is shown in US Patent Number U.S. Pat. No. 5,150,770A, assigned to Contraves Italiana S.p.A., and discloses a spring operated recharge device. There are two problems with the Contraves device, namely it is difficult to recharge quickly in a reciprocating manner and secondly it is difficult to discharge the energy to a transmission system without losses occuring.

A seventh type of SMA engine is shown in US patent publication number US2007/261307A1, assigned to Breezway Australia Pty Limited, and discloses an energy recovery charge system for automated window system. Breezway discloses a SMA wire that is coupled to a piston which is used to pump fluid to a pressurised accumulator. The piston therefore moves in tandem with the SMA wire as it contracts and expands. By coupling the SMA wire to the piston in this manner, the SMA wire is in indirect communication with the energy accumulator via the pumped fluid which is ineffiecient and the Breezway system suffers from the same problems as Contraves. Other patent publications in the art include US2002/069941; JP61035178; EP0045250; WO2007/134088; US2005/160858 and JP06249129.

In addition one of the difficulties with each of these types of SMA engines has been that of the cycle period of the SMA material. SMA material is generally relatively slow to expand and contract (10's of RPM). It has been and remains difficult to achieve a worthwhile reciprocating frequency that might be usefully employed in an industrial application (100's to 1000's of RPM). This is not a trivial task and generally is complicated and involves significant parasitic power losses.

The present application is directed to solving at least one of the above mentioned problems.

### SUMMARY OF THE INVENTION

According to the invention there is provided, as set out in the appended claims, an energy recovery device comprising:
a drive mechanism configured with a transmission system;
   a SMA engine comprising a length of SMA material fixed at a first end and connected at a second end to the drive mechanism;
an immersion chamber adapted for housing the SMA engine and adapted to be sequentially filled with fluid to allow heating and/or cooling of the SMA engine; and
an output transmission for coupling to and being driven by the transmission system.

In one embodiment the transmission system comprises a gear based transmission system comprising a free wheel/overrunning clutch adapted to enable the return of the SMA engine to a starting position.

In another embodiment there is provided an energy recovery device comprising
a drive mechanism configured with a hydraulic based transmission system;
   a SMA engine comprising a length of SMA material fixed at a first is end and connected at a second end to the drive mechanism;
an immersion chamber adapted for housing the SMA engine and adapted to be sequentially filled with fluid to allow heating and/or cooling of the SMA engine; and
an output transmission for coupling to and being driven by the hydraulic based transmission system.

In one embodiment the hydraulic based transmission system comprises a pumping mechanism for hydraulic fluid and adapted to allow power to be transmitted via the movement of the fluid.

In one embodiment there is provide a hydraulic accumulator adapted to enable a continuous pressure and flow supply to a hydraulic motor whilst accepting a fluctuating supply from a hydraulic pump.

In one embodiment the SMA engine is allowed to return to a starting position through the use of at least one one-way valve on a hydrualic line to ensure that fluid is continuously pumped in only one direction.

The invention provides a means using a Shape Memory Alloy (SMA) actuator as a method for recovering low grade heat from a heated water stream, such as is typical in many industrial and domestic situations, and the conversion of it to mechanical energy. First conception of the benefits of immersion heating and cooling of the working material using a fluid as opposed to surface-area heating of the material.

The presently described invention solves the problem of recovering and converting low grade waste heat (for example as would be available as hot water in many industrial processes, available at <100 degC.) in as simple and cost effective manner as possible.

The use of Shape Memory Alloys for this purpose is an attractive option because such alloys offer compact, power dense conversion of energy at temperatures that would render other technologies unusable.

In a further embodiment there is provided an energy recovery device comprising:
a drive mechanism configured with a gear based transmission system;
   a SMA engine comprising a length of SMA material fixed at a first end and connected at a second end to the drive mechanism; and
an output transmission for coupling to and being driven by the gear based transmission system.

In another embodiment there is provided an energy recovery device comprising
a drive mechanism configured with a hydraulic based transmission system;
   a SMA engine comprising a length of SMA material fixed at a first end and connected at a second end to the one way drive mechanism; and
an output transmission for coupling to and being driven by the hydraulic based transmission system.

In a further embodiment there is provided an energy recovery device comprising
a drive mechanism configured with a hydraulic based or gear based transmission system;
an engine comprising a length of NTE material fixed at a first end and connected at a second end to the drive mechanism;
an immersion chamber adapted for housing the engine and adapted to be sequentially filled with fluid to allow heating and/or cooling of the engine; and
an output transmission for coupling to and being driven by the hydraulic based or gear based transmission system.

### BRIEF DESCRIPTION OF THE DRAWINGS

The invention will be more clearly understood from the following description of an embodiment thereof, given by way of example only, with reference to the accompanying drawings, in which:

FIG. 1 illustrates a schematic representation of Shape Memory Alloy actuator system, according to one embodiment of the invention;

FIG. 2 illustrates a schematic representation of Shape Memory Alloy actuator system, according to another embodiment of the invention;

FIG. 3 illustrates a hydraulic Expansion circuit that enables the return of the SMA working core to its original length according to one embodiment;

FIG. 4 illustrates a hydraulic circuit that enables the transmission of power from the contraction of the SMA engine core, according to one embodiment; and

FIG. 5 illustrates a schematic overview of the positioning of the Expansion and Contraction Ccts in an engine, according to one embodiment.

### DETAILED DESCRIPTION OF THE DRAWINGS

A shape memory alloy (SMA) actuator to recover and convert low grade heat to mechanical work is described in unpublished PCT patent application No. PCT/EP2012/074566, assigned to Exergyn Limited, and incorporated herein fully by reference. The recovered energy is stored in a spring temporarily before being released via the action of releasing a brake caliper or similar. Energy is stored incrementally in the spring (i.e. successive charges from the SMA before release of the spring) by the repetitive contraction of the SMA actuation core. The SMA actuation core is enabled to perform this sequential charging by the use of a plurality of one-way clutches which act to restrain the spring between charges, enabling the SMA core to return to a starting point repeatedly before charging the spring again. When the spring has reached it's full charge, it is released, thus transmitting the stored energy to a flywheel. The flywheel is permitted to maintain it's rotation (i.e. is not restricted by the limited rotational ability of the spring) by the use of a third one-way clutch. When the spring is fully discharged, it may be clamped and recharged whilst the flywheel maintains its rotation. The spring is also used to step up the rotational speed of the power output—the SMA actuation might occur at only 10's of RPM, whilst the output is generally required in 1000's of RPM.

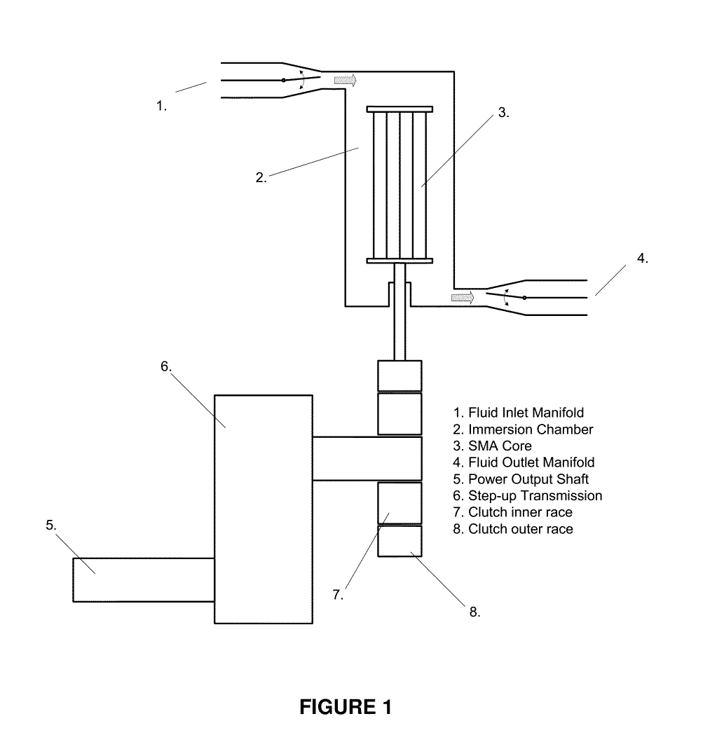

In a first embodiment of the present invention the spring-based transmission system can be replaced with a gear-based transmission system, as illustrated in FIG. 1, indicated by the reference numeral 6. This has the effect of making the power conversion process a “direct-drive” system i.e. work that is recovered and converted by the SMA core is converted directly into high-speed rotational energy using gears and without recourse to a spring. FIG. 1 shows an example of an energy recovery system where an imersion chamber 2 with a fluid inlet 2 and outet 4 houses a SMA core 3. Mechanical energy is transferred to an output shaft 5 via the gear-based transmission system 6.

To use a gear based transmission system 8 instead of a spring, as per the previously mentioned patent PCT application, means that the system is less complex. The previously described invention requires the use of at least three one-way clutches; one to enable the successive charges of the SMA core, one to act against this clutch to enable a ratcheting effect and; one clutch to enable the rotation of the flywheel.

In the present invention, there is only a requirement for a single one way clutch 7, 8—that is adapted to enable the return of the SMA core 3 to it's starting position; there is no need for a ratchet system to restrain the spring, nor is there a need for a separate clutch to enable continuous rotation of the flywheel, although this could be done in certain embodiments. Energy recovered and converted by the SMA core is delivered directly to the drive line. Some of the technical advantages of a free wheel/overruning clutch include power density superior to a rachet system. It can accomodate a higher torque that ratchets. The engagement of these type of mechanisms is more immediate than ratchets.

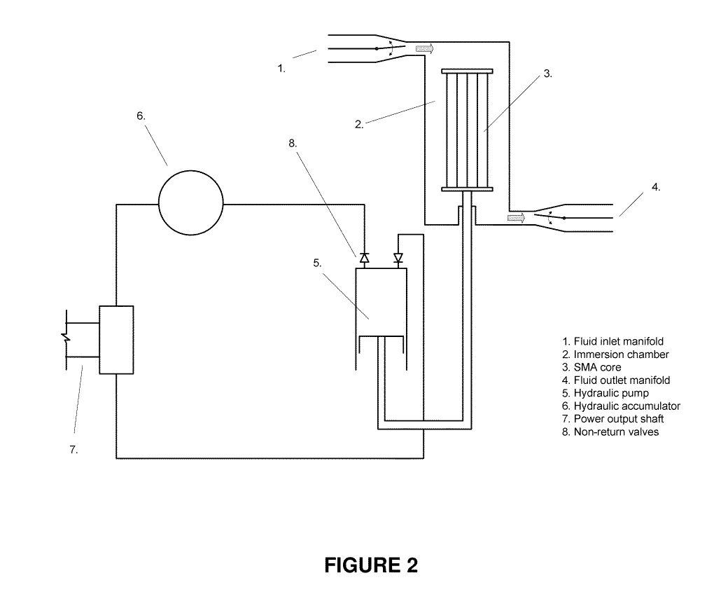

In a second embodiment, as illustrated in FIG. 2 an alternative embodiment may be realised by the replacement of the clutch/spring-based transmission system with a hydraulic-based transmission system 5, 6. In this instance, the linear motion of the SMA core can be utilised directly as a pumping mechanism for hydraulic fluid. In this manner, power may be transmitted via the movement of the fluid, and recovered through some power take-off means, such as a rotary drive or similar. FIG. 2 shows an example of an energy recovery system where an imersion chamber 2 with a fluid inlet 2 and outet 4 houses a SMA core 3. Mechanical energy is transferred to a power output shaft 7 via the hydraulic-based transmission system 5, 6.

In order to overcome the intermittent nature of the power pulses from the SMA core, a hydraulic accumulator 6 is used. Such a vessel enables a continuous pressure and flow supply to the hydraulic motor (as illustrated in FIG. 2) whilst accepting a fluctuating supply from the hydraulic pump.

It will be understood similarly that the inclusion of a hydraulic accumulator 6 in this manner enables the realisation of the system as an energy storage system.

The hydraulic accumulator 6 permits a de-coupling of the energy supply and energy demand processes.

To use a hydraulic transmission instead of a spring, as per the previously mentioned PCT application, means that the system is somewhat less complex; The previously described invention requires the use of at least three one-way clutches; one to enable the successive charges of the SMA core, one to act against this clutch to enable a ratcheting effect and; one clutch to enable the rotation of the flywheel. In the present invention, such clutches are not required, as there is no rotational motion provided at the SMA core itself.

As per the previously mentioned PCT application, there is a requirement for one-way motion of the system, however this is met without the use of mechanical clutches but instead through the use of one-way fluid valves within the hydraulic system.

In the present invention, the SMA core is allowed to return to its starting position without any adverse effects on the system through the use of one-way valves 8 on the hydrualic line. The valves 8 ensure that fluid is continuously pumped in only one direction—thus ensuring that a bi-directional flow regime cannot develop. These one-way valves effectively take the place of the one-way clutch on other versions of the system.

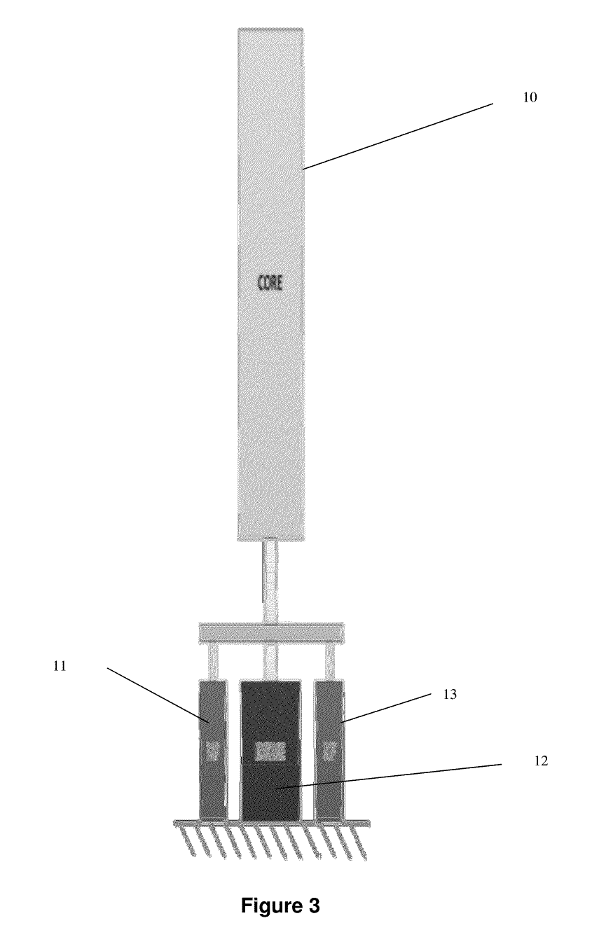

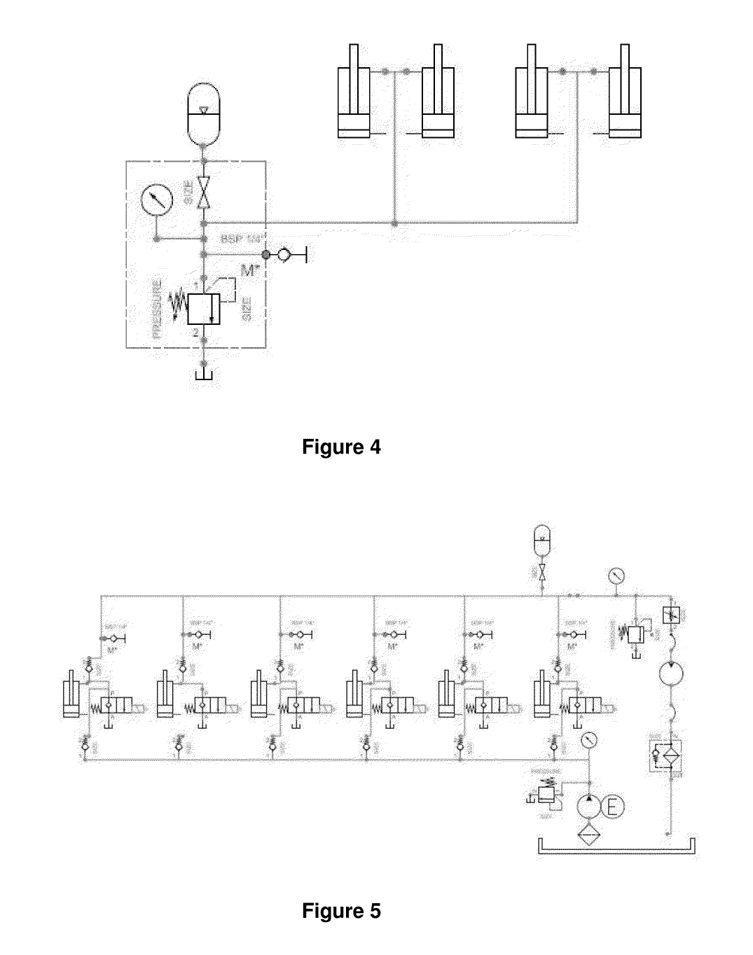

FIG. 3 is a block diagram representing a number of components in the fluid transmission and restoration system. The block identified as the Core 10 represents the assembly containing the SMA material. The SMA inside the core 10 is connected to three actuators 11, 12 and 13 which can operate simultaneously. The two outside blocks illustrated with the initials RF 11 and 12, are restoration or recharge cylinders. They are used to exert a restoration force (RF) on the wire. The block 12 in the centre illustrated as Drive, is the actuator used to pump the fluid to the power generation assembly. The RF and Drive actuators operate from two separate circuits as shown in FIG. 4 and FIG. 5 respectively.

In the RF circuit, a constant pressure is maintained which applies a minimum force on the SMA wire. When the SMA is in a cold martensite condition, this force will extend the wire and provide a downward stroke. On this downward stroke the Drive actuator will be pulled down also. This stroke pulls in fluid into the drive cylinder through a one way valve. The assembly is now charged for the power stroke. When the wire is heated and reverts to the austenite condition, the wire retracts to its original position. When this occurs, the force generated in the wire overcomes the pressure in the restoration line. This forces the fluid back out of the RF cylinders and simultaneously pumps the fluid out of the drive cylinder through a one way valve. When the wire is cooled and the internal structure converts to martensite, the RF pressure will reenter the actuator, extending the wire and the pumping cycle starts over again.

FIG. 4 represents the circuit used to control the restoration actuators. The components include the RF actuators, an accumulator, a shut off valve, a pressure gauge and a pressure relief valve. The pressure required to exert the restoration force is entered into the circuit at the point marked as M*. This pressure is maintained in the line as it is a closed loop system. Any additional pressure beyond the restoration force is dumped back to the tank using the pressure relief valve. During cycling, there is a change in volume as a result of the fluid expanding in and out of the actuators. This change is counteracted by the other restoration cylinders operating a half cycle out and also by the accumulator. The accumulator can be isolated using the shut of valve and the pressure in the line can be monitored by the pressure gauge.

FIG. 5 represents the circuit for the Drive actuator. The components include the Drive actuators, an electric motor, a pump, filters, pressure relief valves, pressure gauges, one way valves, solenoid operated 1/1 valves, an accumulator, a variable flow restrictor and a hydrostatic motor. The drive circuit can be split up into 2 sections, the output and input lines.

The output is a high pressure line accepting the fluid in the power stroke when the wire is retracting. As the actuator pulls up, the flow of fluid is entered through a one way valve maintaining a single flow direction. After the one way valves, the fluid enters a variable flow restrictor which is used to control the flow properties. The flow control is also maintained through an accumulator and a pressure relief valve which is also connected into the line. The fluid is then pumped through a hydrostatic motor which is used to drive the power generation assembly. The fluid then returns to the tank via a filter.

The input line is used to refill the drive cylinder as the restoration cylinder pulls the actuator back down. This can be done by 2 means. The first is through a solenoid operated 1/1 valve and the second is through an electrically operated charging circuit. The 1/1 valve holds a normal operating position of a 1 way valve which allows fluid to be drawn in from the tank but on the power stroke prevents the fluid from returning through the same channel. This facilitates the single direction fluid flow. When the solenoid is activated the valve switches to an unrestricted flow back to the tank. This acts as a pressure release for input line. The secondary charged circuit is used to put a pressure into the line. This is performed by an electric motor and pump which draws the fluid through a filter in the tank and forces it through a series of one way valves into the actuators. This line also has a pressure gauge and pressure relief valve to monitor the line and ensure the system isn't over pressurised.

It will be appreciated that the energy recovery device described with respect to FIGS. 1 and 2 will operate without the use of the immersion chamber.

It will be appreciated that while SMA material/core is substantially described herein with respect to the Figures, the invention can be applied to a class of materials more generally known as ‘active material’ or Negative Thermal Expansion (NTE) materials. NTE materials include those compositions that can exhibit a change in stiffness properties, shape and/or dimensions in response to an activation signal, which can be an electrical, magnetic, thermal or a like field depending on the different types of active materials. Preferred active materials include but are not limited to the class of shape memory materials, and combinations thereof. Shape memory materials, a class of active or NTE materials, also sometimes referred to as smart materials, refer to materials or compositions that have the ability to remember their original shape, which can subsequently be recalled by applying an external stimulus (i.e., an activation signal).

In the specification the terms “comprise, comprises, comprised and comprising” or any variation thereof and the terms include, includes, included and including” or any variation thereof are considered to be totally interchangeable and they should all be afforded the widest possible interpretation and vice versa.

is The invention is not limited to the embodiments hereinbefore described but may be varied in both construction and detail.

1. An energy recovery device comprising:
a drive mechanism configured with a transmission system;
a SMA engine comprising a length of SMA material fixed at a first end and connected at a second end to the drive mechanism;
an immersion chamber adapted for housing the SMA engine and adapted to be sequentially filled with fluid to allow heating and/or cooling of the SMA engine; and
an output transmission for coupling to and being driven by the transmission system.

2. The energy recovery device of claim 1 wherein the transmission system comprises a gear based transmission system comprising a free wheel/overrunning clutch adapted to enable the return of the SMA engine to a starting position.

3. The energy recovery device of claim 1 wherein the transmission system comprises a hydraulic based transmission system comprising a pumping mechanism for hydraulic fluid and adapted to allow power to be transmitted via the movement of the fluid.

4. The energy recovery device as claimed in claim 3 comprising a hydraulic accumulator adapted to enable a continuous pressure and flow supply to a hydraulic motor whilst accepting a fluctuating supply from a hydraulic pump.

5. The energy recovery device as claimed in claim 3 wherein the SMA engine is allowed to return to a starting position through the use of at least one one-way valve on a hydrualic line to ensure that fluid is continuously pumped in only one direction.

6. An energy recovery device comprising
a drive mechanism configured with a hydraulic based transmission system;
a SMA engine comprising a length of SMA material fixed at a first end and connected at a second end to the drive mechanism;
an immersion chamber adapted for housing the SMA engine and adapted to be sequentially filled with fluid to allow heating and/or cooling of the SMA engine; and
an output transmission for coupling to and being driven by the hydraulic based transmission system.

7. The energy recovery device of claim 6 wherein the hydraulic based transmission system comprises a pumping mechanism for hydraulic fluid and adapted to allow power to be transmitted via the movement of the fluid.

8. The energy recovery device as claimed in claim 6 comprising a hydraulic accumulator adapted to enable a continuous pressure and flow supply to a hydraulic motor whilst accepting a fluctuating supply from a hydraulic pump.

9. The energy recovery device as claimed in any claim 6 wherein the SMA engine is allowed to return to a starting position through the use of at least one one-way valve on a hydrualic line to ensure that fluid is continuously pumped in only one direction.

10. An energy recovery device comprising:
a drive mechanism configured with a gear based transmission system;
a SMA engine comprising a length of SMA material fixed at a first end and connected at a second end to the drive mechanism;
an immersion chamber adapted for housing the SMA engine and adapted to be sequentially filled with fluid to allow heating and/or cooling of the SMA engine; and
an output transmission for coupling to and being driven by the gear based transmission system.
